(19) United States
(12) Patent Application Publication
(10) Pub. No.: US 2021/0289751 A1
(43) Pub. Date: Sep. 23, 2021

(54) QUICK-RELEASE EXTENSION FOR A PET LEASH

(71) Applicant: Lisa Denyer, Burlington (CA)

(72) Inventor: Lisa Denyer, Burlington (CA)

(21) Appl. No.: 16/826,795

(22) Filed: Mar. 23, 2020

(51) Int. Cl. A01K 27/00

(52) U.S. Cl. CPC A01K 27/003; A01K 27/005

(57) ABSTRACT

A quick-release extension for a pet leash includes a central portion, and a wrist loop extending from one end of the central portion. A strap is secured to another end of the central portion. The central portion includes a quick release mechanism moveable between an engaged position and a release position. In the engaged position, the quick release mechanism engages a portion of the strap, and a leash loop is formed by a length of the strap between a first end of the strap and the engaged portion of the strap. In the release position, the quick release mechanism is disengaged from the strap. The quick release mechanism may be biased towards the closed position. The quick release mechanism may be configured to be disengaged from the strap in response to the release grip being moved towards the wrist loop.

### FIELD

This disclosure relates generally to an extension for a pet leash, and more specifically to an extension that can be quickly released from the pet leash.

### INTRODUCTION

Leashes for pets, and leashes for dogs in particular, are well known.

Some known dog leashes may be characterized as ‘retractable’ leashes. Typically, a retractable dog leash includes a fixed handle that a user grasps with their fingers and/or palm, and a button that can be operated with the user's thumb to control the extension and/or retraction of a coiled leash.

A possible disadvantage of known retractable leashes is that they typically require a user to continuously hold the handle in their hand. In some cases, a user may prefer to retain a measure of control over the leash, while having both of their hands free for other tasks (e.g. holding an umbrella, a coffee cup, etc.).

Straps that are designed to connect a retractable pet leash to a user's wrist are known.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

Straps that are designed to secure a retractable pet leash to a user's wrist are known. While such straps can provide a ‘hands-free’ method of retaining at least some control over the leash, typically such straps are not designed to be quickly disengaged from the pet leash. This may have one or more disadvantages.

For example, if a dog leash is secured to a user's wrist, the user may be unable to effectively ‘drop’ the pet leash to separate the dog and the user. This may place the user and/or the dog in a harmful situation. For example, if a large dog begins to run or pull uncontrollably on their leash, a user may be pulled in whichever direction the dog goes, even if this is a dangerous direction (e.g. into vehicle traffic). As another example, if a leashed dog and the leash holder end up on opposite sides of a closed elevator door, it may be desirable to rapidly disengage the connection between the dog and the user's wrist.

The leash extension disclosed herein may facilitate ‘hands free’ control over a pet leash, while also facilitating rapid and/or simple disengagement of the pet leash from a user' wrist. In one embodiment, the leash extension may include a wrist loop, a strap, and a quick release mechanism for retaining the strap to form a leash loop.

Providing a leash extension that includes a quick release mechanism may have one or more advantages. For example, in some embodiments a user can simply grasp and pull on a release grip to easily release the leash loop, thereby detaching the leash extension from the pet leash. Accordingly, if a leashed dog begins to run or pull uncontrollably on their leash, a user may simply pull the release grip to detach the leash extension from the pet leash, thereby preventing potential harm to the user and/or to the dog.

In accordance with one broad aspect of this disclosure, there is provided a quick-release extension for a pet leash, the extension comprising: a central portion having a first end and a second end; a wrist loop extending from the first end of the central portion; and a strap having a first end and a second end, the first end of the strap being secured to the second end of the central portion; wherein the central portion comprises a quick release mechanism moveable between an engaged position and a release position, wherein, in the engaged position, the quick release mechanism engages a portion of the strap, and a leash loop is formed by a length of the strap between the first end of the strap and the engaged portion of the strap, wherein, in the release position, the quick release mechanism is disengaged from the strap, and wherein the quick release mechanism is resiliently biased towards the closed position.

In some embodiments, the quick release mechanism comprises a base plate, a rotatable cam lever, and a biasing member configured to rotate the cam lever relative to the base plate.

In some embodiments, the rotatable cam lever comprises an engagement surface, and the biasing member is configured to rotate the engagement surface towards the base plate.

In some embodiments, the engagement surface is knurled.

In some embodiments, the quick release mechanism further comprises a release grip secured to the rotatable cam lever.

In some embodiments, the release grip comprises a handle secured to the rotatable cam lever by a cord.

In some embodiments, the quick-release extension further comprises an accessory loop secured to the central portion.

In some embodiments, the accessory loop and the quick release mechanism are provided on opposite sides of the central portion.

In some embodiments, the quick-release extension further comprises at least one wrist pad provided on an inner face of the wrist loop.

In accordance with another broad aspect of this disclosure, there is provided a quick-release extension for a pet leash, the extension comprising: a central portion having a first end and a second end; a wrist loop extending from the first end of the central portion; and a strap having a first end and a second end, the first end of the strap being secured to the second end of the central portion; wherein the central portion comprises a quick release mechanism, the quick release mechanism being configured to engage a portion of the strap, wherein a leash loop is formed by a length of the strap between the first end of the strap and the engaged portion of the strap, and wherein the quick release mechanism comprises a release grip, and wherein the quick release mechanism is configured to be disengaged from the strap in response to the release grip being moved towards the wrist loop.

In some embodiments, the quick release mechanism comprises a base plate, a rotatable cam lever, and a biasing member configured to rotate the cam lever relative to the base plate, and the release grip is secured to the rotatable cam lever.

In some embodiments, the rotatable cam lever comprises an engagement surface, and the biasing member is configured to rotate the engagement surface towards the base plate.

In some embodiments, the engagement surface is knurled.

In some embodiments, the release grip comprises a handle secured to the rotatable cam lever by a cord.

In some embodiments, the quick-release extension further comprises an accessory loop secured to the central portion.

In some embodiments, the accessory loop and the quick release mechanism are provided on opposite sides of the central portion.

In some embodiments, the quick-release extension further comprises at least one wrist pad provided on an inner face of the wrist loop.

It will be appreciated by a person skilled in the art that a method or apparatus disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a perspective view of quick-release extension for a pet leash in accordance with one embodiment;

FIG. 2 is a perspective view of the quick-release extension of FIG. 1, with a retractable pet leash positioned in a leash loop of the extension;

FIG. 3 is a top plan view of the quick-release extension of FIG. 1;

FIG. 4 is a bottom plan view of the quick-release extension of FIG. 1;

FIG. 5 is a front plan view of the quick-release extension of FIG. 1;

FIG. 6 is a rear plan view of the quick-release extension of FIG. 1;

FIG. 7 is a perspective view of the quick-release extension of FIG. 1, with a quick release mechanism in a release position;

FIG. 8A is a side elevation view of the quick-release extension of FIG. 1, with a quick release mechanism in an engaged position, holding a portion of a strap to form a leash loop;

FIG. 8B is a side elevation view of the quick-release extension of FIG. 8A, with the quick release mechanism in a release position; and

FIG. 8C is a side elevation view of the quick-release extension of FIG. 8A, with the quick release mechanism in the release position, and the strap no longer forming a leash loop.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

While the apparatus and methods disclosed herein are described specifically in relation to and in use with a retractable leash for a dog, it will be appreciated that the apparatus and methods may alternatively be used with non-retractable leashes, and/or with leashes for other pets.

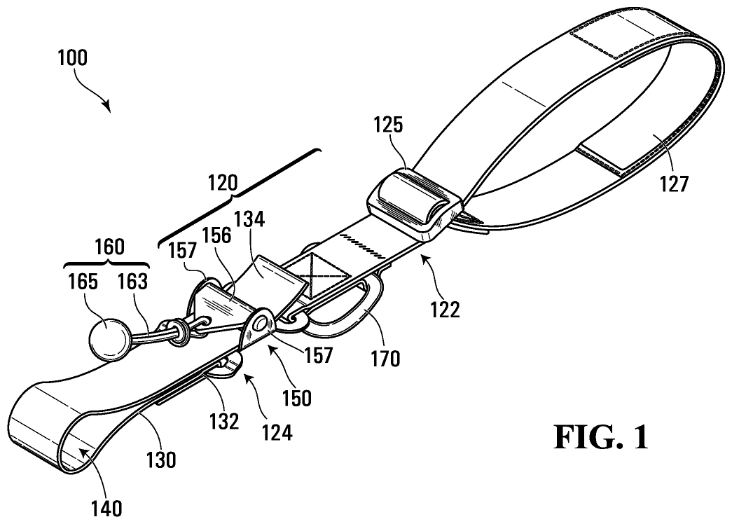

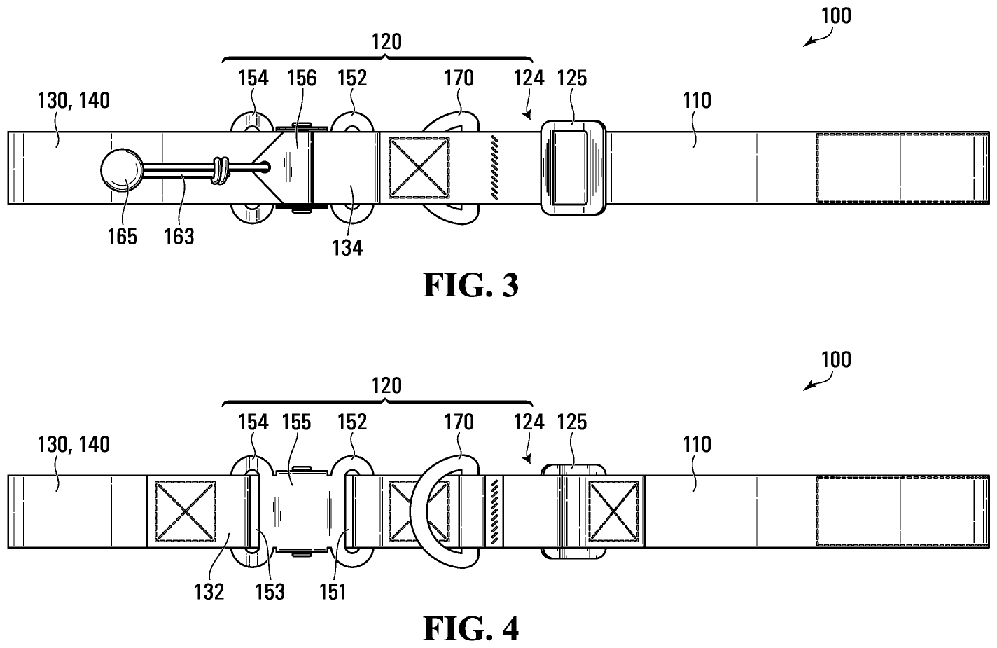

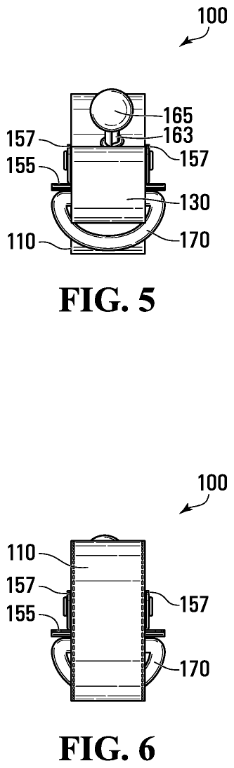

FIGS. 1 to 8 illustrate an example embodiment of a quick-release extension for a pet leash, referred to generally as 100. With reference to FIG. 1, leash extension 100 includes a wrist loop 110, and a central portion 120. Leash extension 100 also includes a strap 130 that, when retained by a quick release mechanism 150, forms a leash loop 140.

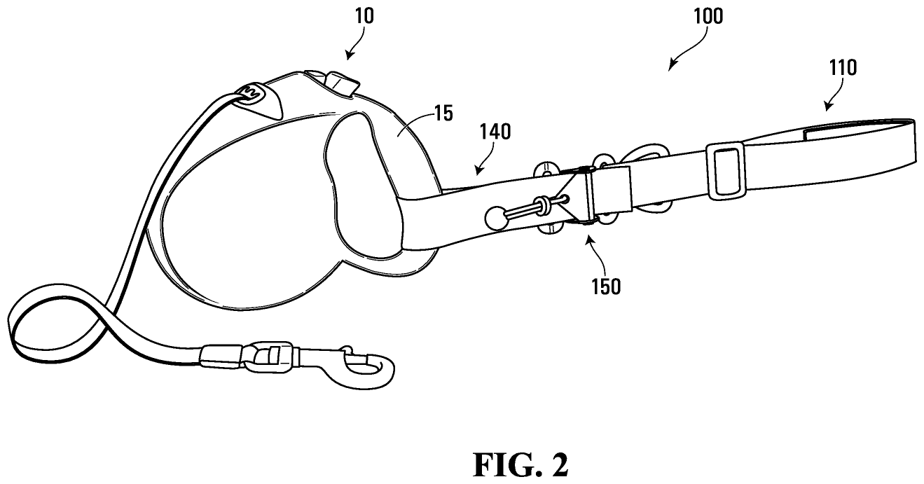

With reference to FIG. 2, in use, leash loop 140 may be formed around a portion of a pet leash (e.g. a handle 15 of a retractable pet leash 10 as in the illustrated example) in order to secure the pet leash 10 to leash extension 100. For example, an end 134 of strap 130 may be fed through handle 15 before strap 130 is engaged by quick release mechanism 150. In the arrangement illustrated in FIG. 2, when a user positions their wrist in wrist loop 100, pet leash 10 will be connected to their wrist via leash extension 100, allowing for ‘hands free’ retention of pet leash 10.

Returning to FIG. 1, wrist loop 110 extends from a first end 122 of central portion 120. In the illustrated embodiment, a slider 125 allows for adjustment of the diameter of wrist loop 110, e.g. to suit a user's wrist and/or hand size. In the illustrated example, slider 125 is a 3-bar slider. It will be appreciated that any suitable adjustment mechanism known in the art may be used in one or more alternative embodiments. Alternatively, wrist loop 100 may have a fixed diameter.

In the illustrated example, wrist loop 100 includes an optional wrist pad 127 positioned on an inwardly-facing surface of wrist loop 100. Any suitable padding known in the art may be used. For example, wrist pad 127 may be made from a padded polyester air mesh. While a single wrist pad 127 is illustrated, it will be appreciated that two or more separate wrist pads may be provided in alternative embodiments.

Strap 130 extends from a second end 124 of central portion 120. In the illustrated example, a first end 132 of strap 130 is secured to a baseplate 155 of quick release mechanism 150. Strap 130 extends from first end 123 to a second end 134. Strap 130 may be of any suitable length. Preferably, strap 130 is long enough to facilitate securement of leash extension 100 to a variety of known retractable leash handle diameters.

Strap 130 and wrist loop 100 may be made from any suitable material. For example, nylon webbing may be used to form one or both of strap 130 and wrist loop 100.

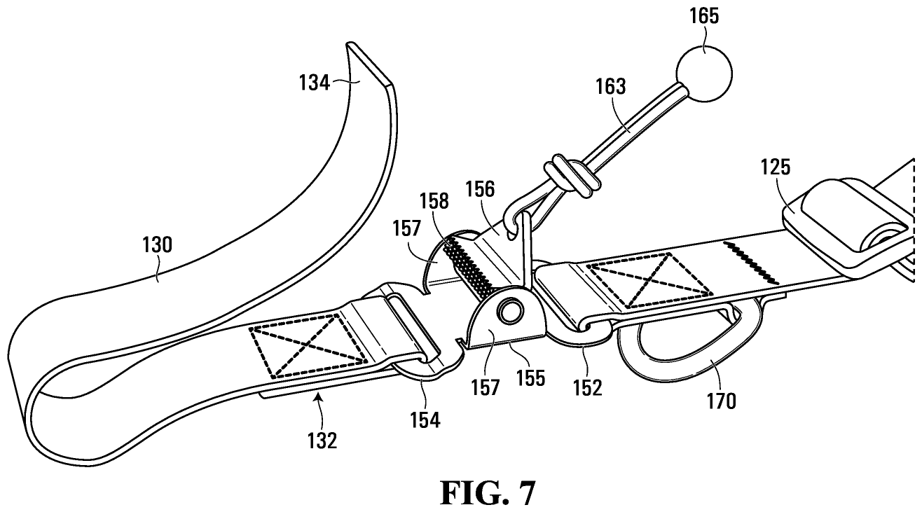

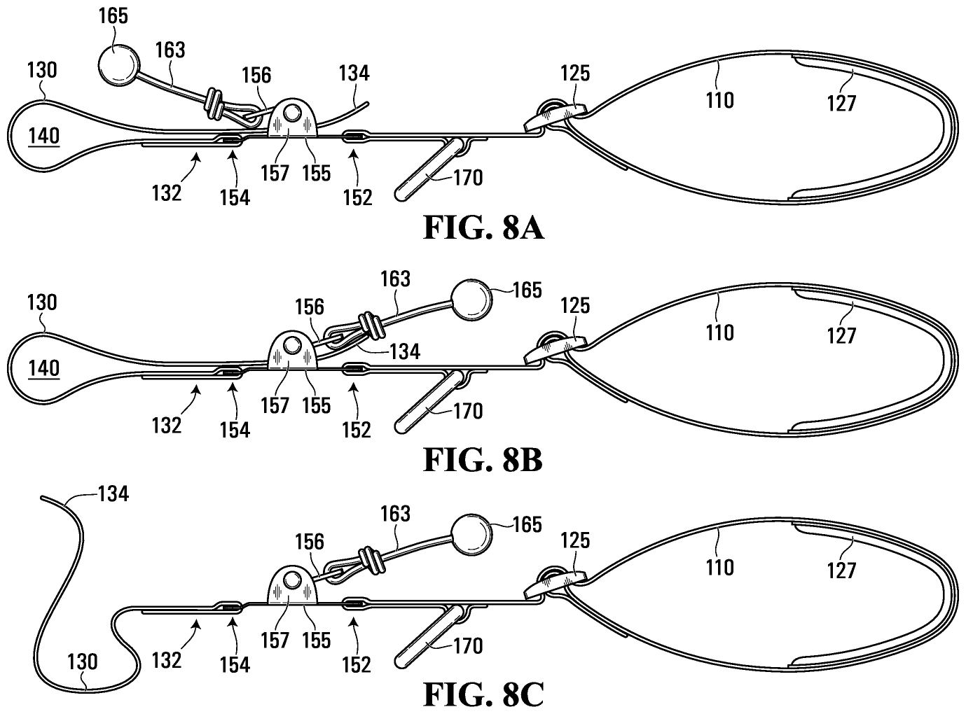

Turning to FIGS. 7 and 8A-C, quick release mechanism 150 includes a baseplate 155 that is secured to both strap 130 and wrist loop 110. In the illustrated example, baseplate 155 has a first slot 151 proximate a first end 152 of quick release mechanism 150, and end of a strap extending from wrist loop 110 is secured to baseplate 155 via the slot 151. Baseplate 155 also has a second slot 153 proximate a second end 154 of quick release mechanism 150, and end 132 of a strap 130 is secured to baseplate 155 via the slot 153. It will be appreciated that wrist loop 100 and/or strap 130 may be secured to baseplate 155 in any suitable manner known in the art.

With reference to FIG. 7, quick release mechanism 150 includes a cam lever 156 that is rotationally coupled to baseplate 155. Specifically, in the illustrated example, cam lever 156 is mounted between flanges 157 that extend from baseplate 155.

Cam lever 156 has an engagement surface 158 that is configured to engage a face of strap 130. Optionally, as shown in the illustrated example, engagement surface 158 may be knurled to increase engagement between quick release mechanism 150 and strap 130, as discussed further below.

Cam lever 156 and baseplate 155 may be made from any suitable material. For example, aluminum may be used to form one or both of cam lever 156 and baseplate 155.

Cam lever 156 may be rotated between an engaged position (e.g. as shown in FIG. 8A), and a release position (e.g. as shown in FIG. 8B). Preferably, cam lever 156 is resiliently biased towards the engaged position. For example, quick release mechanism 150 may include a torsion spring (not shown) to bias cam lever 156 towards a position in which engagement surface 158 is proximate baseplate 155.

To facilitate rotation of cam lever 156 by a user, a release grip is preferably secured to cam lever 156. In the illustrated example, release grip 160 includes a handle 165 in the form of a ball secured to cam lever 156 by a flexible cord or rope 163. It will be appreciated that any suitable grip and/or handle known in the art may be used in one or more alternative embodiments.

Optionally, handle 165 and/or flexible cord 163 may be provided with one or more reflective surfaces, which may increase its visibility at night. For example, cord 163 may include strands of a reflective material.

Optionally, handle 165 and/or flexible cord 163 may be made from or coated with a ‘non-slip’ material (e.g. rubber), which may increase friction between a user's hand and the release grip. For example, this may be beneficial when a user is wearing gloves, mittens, or the like.

In an engaged position, a portion of strap 130 positioned between engagement surface 158 and baseplate 155 may be retained in such a position to form leash loop 140.

For example, to form leash loop 140, cam lever 156 may be rotated to the release position shown in FIG. 8C, the second end 134 of strap 130 may be positioned between engagement surface 158 and baseplate 155 of quick release mechanism 150 while cam lever 156 is held in the release position (e.g. as shown in FIG. 8B), and then cam lever 156 may be released and allowed to return, under the bias of e.g. a torsion spring, to an engaged position (e.g. as shown in FIG. 8A).

To disengage or release leash loop 140, cam lever 156 may be rotated from the engaged position shown in FIG. 8A, to the release position shown in FIG. 8B, the release position allowing the second end 134 of strap 130 to slip out of quick release mechanism 150, as shown in FIG. 8C.

Returning to FIG. 1, leash extension 100 may include an optional accessory loop 170. In the illustrated example, accessory loop 170 is in the form of a D-ring secured to central portion 120. Accessory loop may facilitate attachment of e.g. one or more objects that may be useful when walking a dog. For example, a ‘doggy bag’ dispenser, a flashlight, a set of keys, etc. may be attached to leash extension 100 via accessory loop 170.

In the illustrated example, accessory loop 170 and release grip 160 are provided on opposite sides of central portion 120. Such an arrangement may advantageously inhibit confusion as to what to grab to release leash loop 140. Alternatively, accessory loop 170 and release grip 160 may be provided on the same side of central portion 120.

Providing a leash extension having a quick release mechanism as disclosed herein may have one or more advantages. For example, to disengage or release leash loop 140 (thereby releasing a pet leash secured by leash loop 140 from leash extension 100), a user may simply have to grasp some or all of release grip 160 and rotate cam lever 156 to a release position. Facilitating the disengagement of leash extension 100 from a dog leash through a single, simple action may reduce the chances that a user is unable to quickly disengage from a dog leash, e.g. in the context of an urgent or emergency situation where timing may be critical.

As another example, to disengage or release leash loop 140 a user may simply pull release grip 160 in a direction towards wrist loop 100. In some cases, this may be performed by a user using their tethered hand (i.e. the hand extending from the wrist around which wrist loop 110 is positioned).

Also, in the illustrated example, quick release mechanism 150 is provided as part of the central portion 120. Put another way, quick release mechanism 150 (and release grip 160) is positioned between wrist loop 110 and leash loop 140. Providing quick release mechanism 150 (and release grip 160) in such a position may have one or more advantages.

For example, in such a position the operation of quick release mechanism 150 may be relatively unaffected by tension in wrist loop 110 or by tension in leash loop 140.

As another example, in such a position release grip 160 may be relatively easy for a user to locate (e.g. in an emergency situation), in contrast to a release mechanism located on wrist loop 110 or on leash loop 140.

Also, in the illustrated example, leash extension 100 does not include any components that are designed to detach from leash extension 100 during normal operation. For example, when leash loop 140 is released or disengaged (thereby releasing a pet leash secured by leash loop 140, no portion of leash extension 100 remains attached to the pet leash.

As used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A quick-release extension for a pet leash, the extension comprising:
a central portion having a first end and a second end;
a wrist loop extending from the first end of the central portion; and
a strap having a first end and a second end, the first end of the strap being secured to the second end of the central portion;
wherein the central portion comprises a quick release mechanism moveable between an engaged position and a release position,
wherein, in the engaged position, the quick release mechanism engages a portion of the strap, and a leash loop is formed by a length of the strap between the first end of the strap and the engaged portion of the strap,
wherein, in the release position, the quick release mechanism is disengaged from the strap, and
wherein the quick release mechanism is resiliently biased towards the closed position.

2. The extension of claim 1, wherein the quick release mechanism comprises a base plate, a rotatable cam lever, and a biasing member configured to rotate the cam lever relative to the base plate.

3. The extension of claim 2, wherein the rotatable cam lever comprises an engagement surface, and wherein the biasing member is configured to rotate the engagement surface towards the base plate.

4. The extension of claim 3, wherein the engagement surface is knurled.

5. The extension of claim 2, wherein the quick release mechanism further comprises a release grip secured to the rotatable cam lever.

6. The extension of claim 5, wherein the release grip comprises a handle secured to the rotatable cam lever by a cord.

7. The extension of claim 1, further comprising an accessory loop secured to the central portion.

8. The extension of claim 7, wherein the accessory loop and the quick release mechanism are provided on opposite sides of the central portion.

9. The extension of claim 1, further comprising at least one wrist pad provided on an inner face of the wrist loop.

10. A quick-release extension for a pet leash, the extension comprising:
a central portion having a first end and a second end;
a wrist loop extending from the first end of the central portion; and
a strap having a first end and a second end, the first end of the strap being secured to the second end of the central portion;
wherein the central portion comprises a quick release mechanism, the quick release mechanism being configured to engage a portion of the strap, wherein a leash loop is formed by a length of the strap between the first end of the strap and the engaged portion of the strap, and
wherein the quick release mechanism comprises a release grip, and wherein the quick release mechanism is configured to be disengaged from the strap in response to the release grip being moved towards the wrist loop.

11. The extension of claim 10, wherein the quick release mechanism comprises a base plate, a rotatable cam lever, and a biasing member configured to rotate the cam lever relative to the base plate, and wherein the release grip is secured to the rotatable cam lever.

12. The extension of claim 11, wherein the rotatable cam lever comprises an engagement surface, and wherein the biasing member is configured to rotate the engagement surface towards the base plate.

13. The extension of claim 12, wherein the engagement surface is knurled.

14. The extension of claim 11, wherein the release grip comprises a handle secured to the rotatable cam lever by a cord.

15. The extension of claim 10, further comprising an accessory loop secured to the central portion.

16. The extension of claim 15, wherein the accessory loop and the quick release mechanism are provided on opposite sides of the central portion.

17. The extension of claim 10, further comprising at least one wrist pad provided on an inner face of the wrist loop.
